(19) United States
(12) Patent Application Publication
(10) Pub. No.: US 2026/0342508 A1
(43) Pub. Date: Oct. 29, 2026

(54) SCHEDULING CONFIGURATIONS FOR ANALOG BEAMFORMING WITH DISCRETE ANTENNA ELEMENTS

(71) Applicant: QUALCOMM Incorporated, San Diego, CA (US)

(72) Inventors: Vasanthan RAGHAVAN, West Windsor Township, NJ (US); Yu ZHANG, San Diego, CA (US)

(21) Appl. No.: 19/188,178

(22) Filed: Apr. 24, 2025

(51) Int. Cl. H04L 5/00; H04W 72/23

(52) U.S. Cl. CPC H04L 5/0048; H04W 72/23

(57) ABSTRACT

Various aspects of the present disclosure generally relate to wireless communication. In some aspects, scheduling configurations may be utilized for ABF techniques that use discrete antennas, including in relatively lower frequency ranges. In some aspects, a user equipment (UE) may transmit, to a network node, an indication of a threshold quantity of channel state information reference signal (CSI-RS) symbols for time-division multiplexing with a physical downlink shared channel (PDSCH) communication. The indication may be related to one or more analog beamforming (ABF) beam weights for one or more discrete antenna elements. The UE may then receive, from the network node, a scheduling configuration for PDSCH and CSI-RS symbol multiplexing in accordance with the indication.

### FIELD OF THE DISCLOSURE

Aspects of the present disclosure generally relate to wireless communication and specifically relate to techniques, apparatuses, and methods associated with scheduling configurations for enabling analog beamforming with discrete antenna elements.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Wireless communications networks may utilize antenna technologies to improve signal quality and system performance. For example, analog beamforming (ABF) may be used to improve communication performance in higher frequency bands. ABF includes the use of phase shifters or amplitude control to co-phase antenna elements at a radio frequency of interest. ABF is typically utilized at millimeter wave (mmWave) frequency bands to improve a link budget of mmWave systems that experience increased blockage, penetration, and path losses. In some ABF systems, antennas may be pre-grouped across polarizations within an antenna module design, which may allow for efficient co-phasing and steering of energy toward one or more targeted directions.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, to a network node, an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements. The processing system may be configured to cause the UE to receive, from the network node, a scheduling configuration, for PDSCH and CSI-RS symbol multiplexing, in accordance with the indication.

Some aspects described herein relate to a network node. The network node may include a processing system. The processing system may include one or more processors and one or more code-storing memories coupled with the one or more processors. The processing system may be configured to cause the network node to receive, from a UE, an indication of a threshold quantity of CSI-RS symbols for time-division multiplexing with a PDSCH communication, related to one or more ABF beam weights for one or more discrete antenna elements. The processing system may be configured to cause the network node to transmit, to the UE, a scheduling configuration, for PDSCH and CSI-RS symbol multiplexing, in accordance with the indication.

Some aspects described herein relate to a method for wireless communication by a UE. The method may include transmitting, to a network node, an indication of a threshold quantity of CSI-RS symbols for time-division multiplexing with a PDSCH communication, related to one or more ABF beam weights for one or more discrete antenna elements. The method may include receiving, from the network node, a scheduling configuration, for PDSCH and CSI-RS symbol multiplexing, in accordance with the indication.

Some aspects described herein relate to a method for wireless communication by a network node. The method may include receiving, from a UE, an indication of a threshold quantity of CSI-RS symbols for time-division multiplexing with a PDSCH communication, related to one or more ABF beam weights for one or more discrete antenna elements. The method may include transmitting, to the UE, a scheduling configuration, for PDSCH and CSI-RS symbol multiplexing, in accordance with the indication.

Some aspects described herein relate to a non-transitory computer-readable medium that stores a set of instructions for wireless communication by a UE. The set of instructions, when executed by one or more processors of the UE, may cause the UE to transmit, to a network node, an indication of a threshold quantity of CSI-RS symbols for time-division multiplexing with a PDSCH communication, related to one or more ABF beam weights for one or more discrete antenna elements. The set of instructions, when executed by one or more processors of the UE, may cause the UE to receive, from the network node, a scheduling configuration, for PDSCH and CSI-RS symbol multiplexing, in accordance with the indication.

Some aspects described herein relate to a non-transitory computer-readable medium that stores a set of instructions for wireless communication by a network node. The set of instructions, when executed by one or more processors of the network node, may cause the network node to receive, from a UE, an indication of a threshold quantity of CSI-RS symbols for time-division multiplexing with a PDSCH communication, related to one or more ABF beam weights for one or more discrete antenna elements. The set of instructions, when executed by one or more processors of the network node, may cause the network node to transmit, to the UE, a scheduling configuration, for PDSCH and CSI-RS symbol multiplexing, in accordance with the indication.

Some aspects described herein relate to an apparatus for wireless communication. The apparatus may include means for transmitting, to a network node, an indication of a threshold quantity of CSI-RS symbols for time-division multiplexing with a PDSCH communication, related to one or more ABF beam weights for one or more discrete antenna elements. The apparatus may include means for receiving, from the network node, a scheduling configuration, for PDSCH and CSI-RS symbol multiplexing, in accordance with the indication.

Some aspects described herein relate to an apparatus for wireless communication. The apparatus may include means for receiving, from a UE, an indication of a threshold quantity of CSI-RS symbols for time-division multiplexing with a PDSCH communication, related to one or more ABF beam weights for one or more discrete antenna elements. The apparatus may include means for transmitting, to the UE, a scheduling configuration, for PDSCH and CSI-RS symbol multiplexing, in accordance with the indication.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example beamforming architecture that supports beamforming for millimeter wave communications.

FIG. 3 is a diagram illustrating examples of channel state information reference signal (CSI-RS) beam management procedures.

FIG. 4 is a diagram illustrating an example of multiplexing of physical downlink shared channel and CSI-RS for analog beamforming (ABF).

FIG. 5 is a diagram illustrating an example associated with scheduling configurations for ABF with discrete antenna elements.

FIG. 6 is a flowchart illustrating an example process performed, for example, at a user equipment (UE) or an apparatus of a UE that supports scheduling configurations for ABF with discrete antenna elements.

FIG. 7 is a flowchart illustrating an example process performed, for example, at a network node or an apparatus of a network node that supports scheduling configurations for ABF with discrete antenna elements.

FIGS. 8-9 are diagrams of example apparatuses for wireless communication that support scheduling configurations for ABF with discrete antenna elements.

### DETAILED DESCRIPTION

Wireless communications networks may utilize different antenna technologies to improve signal quality and system performance. For example, analog beamforming (ABF) may be used to improve communication performance in higher frequency bands. ABF may include the use of phase shifters or amplitude control to co-phase antenna elements at a radio frequency (RF) of interest. ABF may be utilized in millimeter wave (mmWave) frequency bands (for example, frequency range 2 (FR2)) to improve a link budget of mmWave systems that experience increased blockage, penetration, and path losses. In some ABF systems, antennas may be pre-grouped across polarizations within an antenna module design, which may allow for efficient co-phasing and steering of energy toward one or more targeted directions. Additionally, ABF may be used in accordance with other beam properties in applications other than steering energy in a direction.

Implementing ABF in relatively lower frequency ranges (for example, frequency range 1 (FR1) or frequency range 3 (FR3)) may offer increased power and performance efficiencies for communications of a user equipment (UE) in the network, thereby enhancing overall system performance. However, utilizing ABF techniques in lower frequency ranges (for example, FR1 or FR3) poses challenges. For example, FR1 and FR3 implementations may utilize planar inverted-F antennas (PIFAs) or monopole antennas, which may be unsuitable for ABF. Furthermore, the use of dual-polarized antennas may be unsuitable for ABF applications because dual-polarized antennas utilize a relatively larger area and may not support wideband applications. As a result, practical ABF designs generally utilize monopole antenna designs. However, implementing groups of monopole antennas that can be co-phased for ABF results in a relatively high search overhead. Additionally, the close grouping of antennas and similar ground or housing impacts on the antenna's radiation properties (for example, which are present in mmWave antenna designs) may be unsupported in monopole antenna design. For example, monopole antenna designs may be optimized for location or placement rather than for co-phased elemental patterns.

Furthermore, the scheduling and multiplexing of physical downlink shared channel (PDSCH) and channel state information reference signal (CSI-RS) communications pose challenges in ABF techniques that utilize a discrete antenna design. For example, ABF estimation techniques may rely on a quantity of independent measurements for estimating ABF beam weights over the number of antenna elements being combined for ABF. The quantity of independent measurements may be directly proportional to the quantity of antenna elements being combined for ABF. For example, if two antenna elements are to be co-phased, two independent measurements are utilized. Similarly, if four antenna elements are involved, four independent measurements are utilized. These measurements enable the determination of accurate ABF beam weights. The scheduling configuration for PDSCH and CSI-RS symbols may accommodate these independent measurements. In scenarios where PDSCH and CSI-RS symbols are multiplexed using TDM, a different ABF beam weight may be used for each CSI-RS symbol, facilitating the learning of optimal beam weights. Conversely, when PDSCH and CSI-RS symbols are multiplexed using FDM, the overlap between symbols may impede the acquisition of independent measurements, potentially leading to suboptimal ABF performance. Accordingly, the scheduling configuration may be designed to carefully balance the time and frequency domain multiplexing of PDSCH and CSI-RS symbols to ensure sufficient independent measurements for accurate ABF estimation

For example, such measurements and estimates may be unsupported or may experience decreased accuracy where PDSCH and CSI-RS are scheduled with an overlap (for example, where PDSCH and CSI-RS communications are multiplexed using frequency-division multiplexing (FDM)). As a result, ABF beam weight estimation techniques may be relatively inaccurate or underdetermined where there are fewer independent measurements than antenna elements, leading to suboptimal ABF performance.

Various aspects relate generally to scheduling configurations for ABF techniques that use discrete antennas, including in relatively lower frequency ranges (for example, FR1 or FR3). Some aspects more specifically relate to a UE transmitting, to a network node, an indication of a threshold quantity of CSI-RS symbols for time-division multiplexing (TDM) with a PDSCH communication. The indication may be related to one or more ABF beam weights for one or more discrete antenna elements. The UE may then receive, from the network node, a scheduling configuration for PDSCH and CSI-RS symbol multiplexing in accordance with the indication. In some aspects, the UE may estimate the ABF beam weights in accordance with the scheduling configuration, wherein a first set of ABF beam weights is used with a first set of CSI-RS symbols, and a second set of ABF beam weights is used with a second set of CSI-RS symbols, in accordance with the scheduling configuration. Additionally, the scheduling configuration may relate to one or more beams used in a beam refinement sweeping procedure. In some aspects, the UE may transmit an indication of ABF beam weight estimates when the quantity of CSI-RS symbols is less than the threshold quantity.

Particular aspects of the subject matter described in this disclosure can be implemented to realize one or more of the following potential technical advantages. By transmitting an indication of the threshold quantity of CSI-RS symbols for TDM with PDSCH, the UE enables the network node to adapt the scheduling configuration to the UE's ABF implementation. This may result in increased efficiency in energy usage for targeted beam directions and may lead to an enhancement of the link budget across different antenna configurations. Additionally, by receiving a scheduling configuration that considers the UE's ABF capabilities or ABF implementation, the UE can more accurately estimate ABF beam weights, thereby improving ABF performance under different system conditions and across a relatively wider range of frequencies. Furthermore, the network node may adapt the scheduling configuration to optimize the use of radio resources by efficiently multiplexing CSI-RS symbols via FDM or TDM, thus preserving throughput while minimizing signaling overhead. Such an adaptation to the scheduling configuration may improve spectral efficiency or reduce network congestion. Additionally, the exchange of ABF-related information between the UE and the network node may improve synchronization between the UE and the network node, which may improve signal quality, reduce interference, and improve spectral efficiency.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

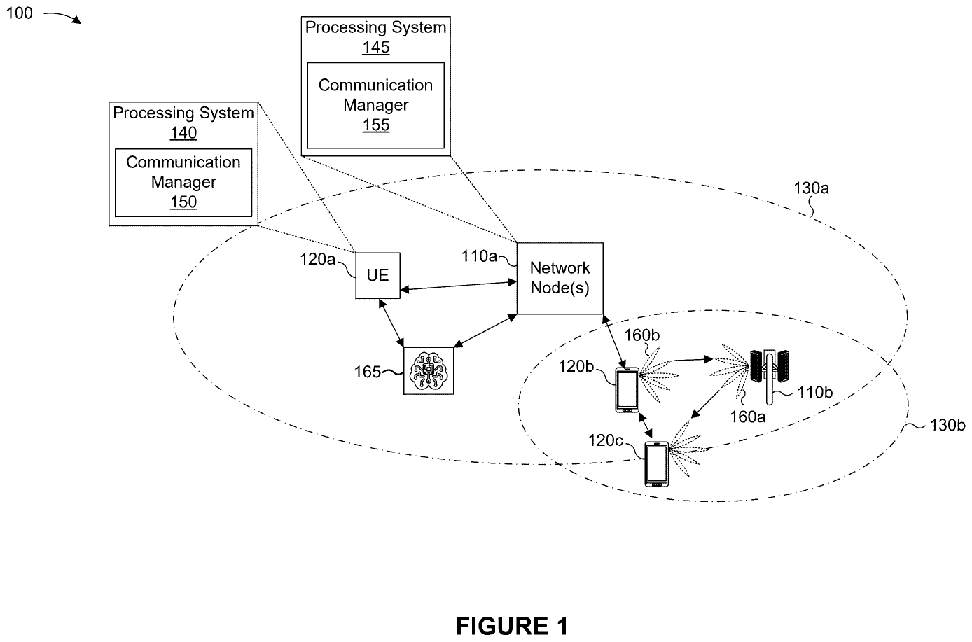

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRA CH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. U plink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. U plink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the A I/ML model (or an instance or portion of the A I/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the A I/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second A I/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/M L model(s) may enable A l-as-a-Service (for example, an end-to-end A l/M L service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable A I/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based A l/M L services via one or more application program interfaces (A PIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit, to a network node 110, an indication of a threshold quantity of CSI-RS symbols for TDM with a PDSCH communication, related to one or more ABF beam weights for one or more discrete antenna elements; and receive, from the network node 110, a scheduling configuration, for PDSCH and CSI-RS symbol multiplexing, in accordance with the indication. Additionally or alternatively, the communication manager 150 may perform one or more other operations described herein.

In some aspects, the network node 110 may include a communication manager 155. As described in more detail elsewhere herein, the communication manager 155 may receive, from a UE 120, an indication of a threshold quantity of CSI-RS symbols for TDM with a PDSCH communication, related to one or more ABF beam weights for one or more discrete antenna elements; and transmit, to the UE 120, a scheduling configuration, for PDSCH and CSI-RS symbol multiplexing, in accordance with the indication. Additionally or alternatively, the communication manager 155 may perform one or more other operations described herein.

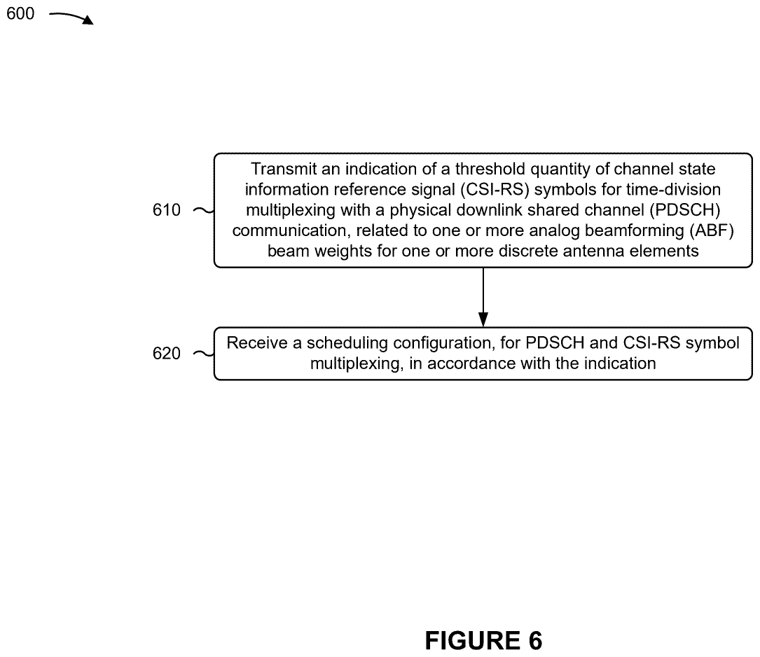

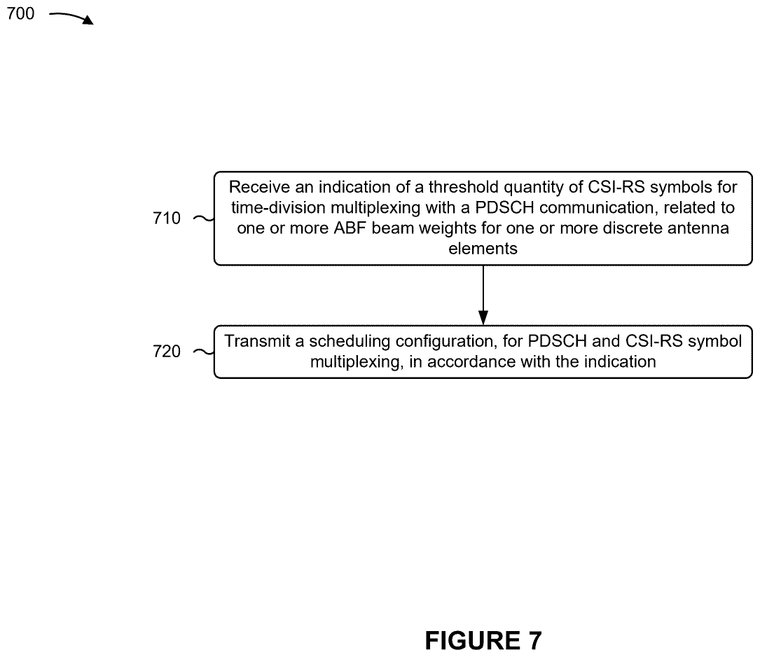

The network node 110, the processing system 145 of the network node 110, the UE 120, the processing system 140 of the UE 120, or any other component(s) of FIG. 1 may implement one or more techniques or perform one or more operations associated with scheduling configurations for ABF with discrete antenna elements, as described in more detail elsewhere herein. For example, the processing system 145 of the network node 110, or the processing system 140 of the UE 120, may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

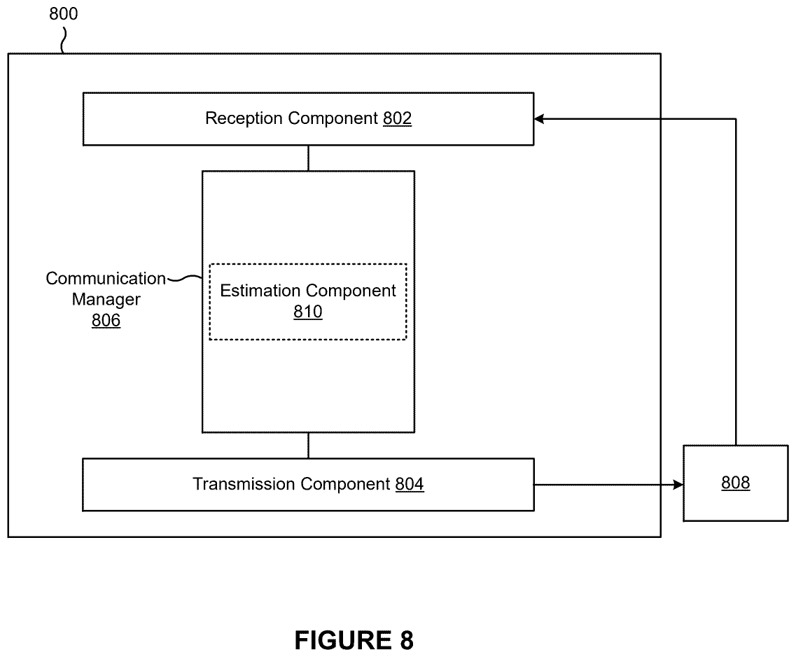

In some aspects, the UE 120 includes means for transmitting, to a network node 110, an indication of a threshold quantity of CSI-RS symbols for TDM with a PDSCH communication, related to one or more ABF beam weights for one or more discrete antenna elements; or means for receiving, from the network node 110, a scheduling configuration, for PDSCH and CSI-RS symbol multiplexing, in accordance with the indication. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

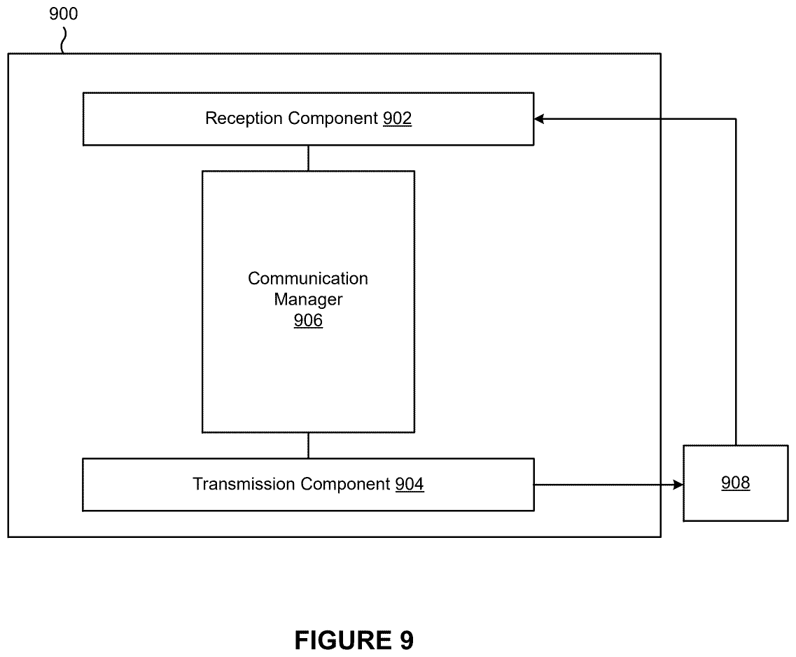

In some aspects, the network node 110 includes means for receiving, from a UE 120, an indication of a threshold quantity of CSI-RS symbols for TDM with a PDSCH communication, related to one or more ABF beam weights for one or more discrete antenna elements; or means for transmitting, to the UE 120, a scheduling configuration, for PDSCH and CSI-RS symbol multiplexing, in accordance with the indication. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

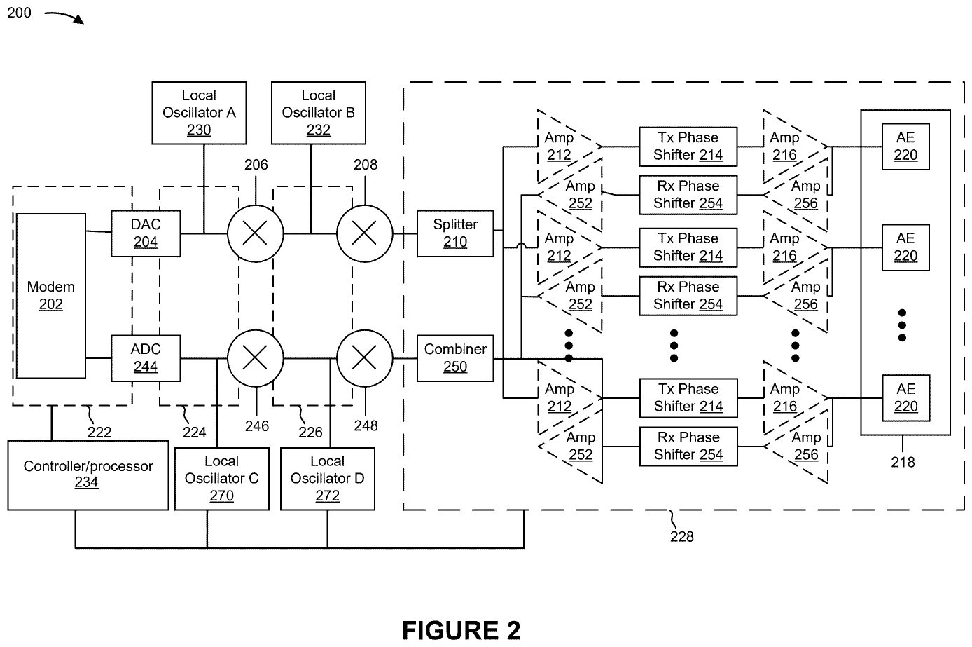

FIG. 2 is a diagram illustrating an example beamforming architecture 200 that supports beamforming for millimeter wave (mmW) communications. In some aspects, architecture 200 may implement aspects of wireless communication network 100. In some aspects, architecture 200 may be implemented in a transmitting device (for example, a first wireless communication device, UE, or network node) or a receiving device (for example, a second wireless communication device, UE, or network node), as described herein.

Broadly, FIG. 2 is a diagram illustrating example hardware components of a wireless communication device in accordance with certain aspects of the disclosure. The illustrated components may include those that may be used for antenna element selection or for beamforming for transmission of wireless signals. There are numerous architectures for antenna element selection and implementing phase shifting, only one example of which is illustrated here. The architecture 200 includes a modem (modulator/demodulator) 202, a digital to analog converter (DAC) 204, a first mixer 206, a second mixer 208, and a splitter 210. The architecture 200 also includes multiple first amplifiers 212, multiple phase shifters 214, multiple second amplifiers 216, and an antenna array 218 that includes multiple antenna elements 220.

Transmission lines or other waveguides, wires, or traces are shown connecting the various components to illustrate how signals to be transmitted may travel between components. Reference numbers 222, 224, 226, and 228 indicate regions in the architecture 200 in which different types of signals travel or are processed. Specifically, reference number 222 indicates a region in which digital baseband signals travel or are processed, reference number 224 indicates a region in which analog baseband signals travel or are processed, reference number 226 indicates a region in which analog intermediate frequency (IF) signals travel or are processed, and reference number 228 indicates a region in which analog RF signals travel or are processed. The architecture also includes a local oscillator A 230, a local oscillator B 232, and a controller/processor 234. In some aspects, controller/processor 234 may be included in the processing system 145 of the network node 110 or the processing system 140 of the UE 120 described above in connection with FIG. 1.

Each of the antenna elements 220 may include one or more sub-elements for radiating or receiving RF signals. For example, a single antenna element 220 may include a first sub-element cross-polarized with a second sub-element that can be used to independently transmit cross-polarized signals. The antenna elements 220 may include patch antennas, dipole antennas, or other types of antennas arranged in a linear pattern, a two dimensional pattern, or another pattern. A spacing between antenna elements 220 may be such that signals with a desired wavelength transmitted separately by the antenna elements 220 may interact or interfere (for example, to form a desired beam). For example, given an expected range of wavelengths or frequencies, the spacing may provide a quarter wavelength, half wavelength, or other fraction of a wavelength of spacing between neighboring antenna elements 220 to allow for interaction or interference of signals transmitted by the separate antenna elements 220 within that expected range.

The modem 202 processes and generates digital baseband signals and may also control operation of the DAC 204, first and second mixers 206, 208, splitter 210, first amplifiers 212, phase shifters 214, or the second amplifiers 216 to transmit signals via one or more or all of the antenna elements 220. The modem 202 may process signals and control operation in accordance with a communication standard such as a wireless standard discussed herein. The DAC 204 may convert digital baseband signals received from the modem 202 (and that are to be transmitted) into analog baseband signals. The first mixer 206 upconverts analog baseband signals to analog IF signals within an IF using a local oscillator A 230. For example, the first mixer 206 may mix the signals with an oscillating signal generated by the local oscillator A 230 to “move” the baseband analog signals to the IF. In some cases, some processing or filtering (not shown) may take place at the IF. The second mixer 208 upconverts the analog IF signals to analog RF signals using the local oscillator B 232. Similar to the first mixer, the second mixer 208 may mix the signals with an oscillating signal generated by the local oscillator B 232 to “move” the IF analog signals to the RF or the frequency at which signals will be transmitted or received. The modem 202 or the controller/processor 234 may adjust the frequency of local oscillator A 230 or the local oscillator B 232 so that a desired IF or RF frequency is produced and used to facilitate processing and transmission of a signal within a desired bandwidth.

In the illustrated architecture 200, signals upconverted by the second mixer 208 are split or duplicated into multiple signals by the splitter 210. The splitter 210 in architecture 200 splits the RF signal into multiple identical or nearly identical RF signals. In other examples, the split may take place with any type of signal, including with baseband digital, baseband analog, or IF analog signals. Each of these signals may correspond to an antenna element 220, and the signal travels through and is processed by amplifiers 212, 216, phase shifters 214, or other elements corresponding to the respective antenna element 220 to be provided to and transmitted by the corresponding antenna element 220 of the antenna array 218. In one example, the splitter 210 may be an active splitter that is connected to a power supply and provides some gain so that RF signals exiting the splitter 210 are at a power level equal to or greater than the signal entering the splitter 210. In another example, the splitter 210 is a passive splitter that is not connected to power supply and the RF signals exiting the splitter 210 may be at a power level lower than the RF signal entering the splitter 210.

After being split by the splitter 210, the resulting RF signals may enter an amplifier, such as a first amplifier 212, or a phase shifter 214 corresponding to an antenna element 220. The first and second amplifiers 212, 216 are illustrated with dashed lines because one or both of them might not be necessary in some aspects. In some aspects, both the first amplifier 212 and second amplifier 216 are present. In some aspects, neither the first amplifier 212 nor the second amplifier 216 is present. In some aspects, one of the two amplifiers 212, 216 is present but not the other. By way of example, if the splitter 210 is an active splitter, the first amplifier 212 may not be used. By way of further example, if the phase shifter 214 is an active phase shifter that can provide a gain, the second amplifier 216 might not be used.

The amplifiers 212, 216 may provide a desired level of positive or negative gain. A positive gain (positive dB) may be used to increase an amplitude of a signal for radiation by a specific antenna element 220. A negative gain (negative dB) may be used to decrease an amplitude or suppress radiation of the signal by a specific antenna element. Each of the amplifiers 212, 216 may be controlled independently (for example, by the modem 202 or the controller/processor 234) to provide independent control of the gain for each antenna element 220. For example, the modem 202 or the controller/processor 234 may have at least one control line connected to each of the splitter 210, first amplifiers 212, phase shifters 214, or second amplifiers 216 that may be used to configure a gain to provide a desired amount of gain for each component and thus each antenna element 220.

The phase shifter 214 may provide a configurable phase shift or phase offset to a corresponding RF signal to be transmitted. The phase shifter 214 may be a passive phase shifter not directly connected to a power supply. Passive phase shifters might introduce some insertion loss. The second amplifier 216 may boost the signal to compensate for the insertion loss. The phase shifter 214 may be an active phase shifter connected to a power supply such that the active phase shifter provides some amount of gain or prevents insertion loss. The settings of each of the phase shifters 214 are independent, meaning that each can be independently set to provide a desired amount of phase shift or the same amount of phase shift or some other configuration. The modem 202 or the controller/processor 234 may have at least one control line connected to each of the phase shifters 214 and which may be used to configure the phase shifters 214 to provide a desired amount of phase shift or phase offset between antenna elements 220.

In the illustrated architecture 200, RF signals received by the antenna elements 220 are provided to one or more first amplifiers 256 to boost the signal strength. The first amplifiers 256 may be connected to the same antenna arrays 218 (for example, for time division duplex (TDD) operations). The first amplifiers 256 may be connected to different antenna arrays 218. The boosted RF signal is input into one or more phase shifters 254 to provide a configurable phase shift or phase offset for the corresponding received RF signal to enable reception via one or more Rx beams. The phase shifter 254 may be an active phase shifter or a passive phase shifter. The settings of the phase shifters 254 are independent, meaning that each can be independently set to provide a desired amount of phase shift or the same amount of phase shift or some other configuration. The modem 202 or the controller/processor 234 may have at least one control line connected to each of the phase shifters 254 and which may be used to configure the phase shifters 254 to provide a desired amount of phase shift or phase offset between antenna elements 220 to enable reception via one or more Rx beams.

The outputs of the phase shifters 254 may be input to one or more second amplifiers 252 for signal amplification of the phase shifted received RF signals. The second amplifiers 252 may be individually configured to provide a configured amount of gain. The second amplifiers 252 may be individually configured to provide an amount of gain to ensure that the signals input to combiner 250 have the same magnitude. The amplifiers 252 or 256 are illustrated in dashed lines because they might not be necessary in some aspects. In some aspects, both the amplifier 252 and the amplifier 256 are present. In another aspect, neither the amplifier 252 nor the amplifier 256 are present. In other aspects, one of the amplifiers 252, 256 is present but not the other.

In the illustrated architecture 200, signals output by the phase shifters 254 (via the amplifiers 252 when present) are combined in combiner 250. The combiner 250 in architecture 200 combines the RF signal into a signal. The combiner 250 may be a passive combiner (for example, not connected to a power source), which may result in some insertion loss. The combiner 250 may be an active combiner (for example, connected to a power source), which may result in some signal gain. When combiner 250 is an active combiner, it may provide a different (for example, configurable) amount of gain for each input signal so that the input signals have the same magnitude when they are combined. When combiner 250 is an active combiner, the combiner 250 may not need the second amplifier 252 because the active combiner may provide the signal amplification.

The output of the combiner 250 is input into mixers 248 and 246. Mixers 248 and 246 generally down convert the received RF signal using inputs from local oscillators 272 and 270, respectively, to create intermediate or baseband signals that carry the encoded and modulated information. The output of the mixers 248 and 246 are input into an ADC 244 for conversion to digital signals. The digital signals output from ADC 244 are input to modem 202 for baseband processing, such as decoding, de-interleaving, or similar operations.

The architecture 200 is given by way of example only to illustrate an architecture for transmitting or receiving signals. In some cases, the architecture 200 or each portion of the architecture 200 may be repeated multiple times within an architecture to accommodate or provide an arbitrary number of RF chains, antenna elements, or antenna panels. Furthermore, numerous alternate architectures are possible and contemplated. For example, although only a single antenna array 218 is shown, two, three, or more antenna arrays may be included, each with one or more of their own corresponding amplifiers, phase shifters, splitters, mixers, DA Cs, ADCs, or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (for example, represented by different ones of the reference numbers 222, 224, 226, 228) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 210, amplifiers 212, 216, or phase shifters 214 may be located between the DAC 204 and the first mixer 206 or between the first mixer 206 and the second mixer 208. In one example, the functions of one or more of the components may be combined into one component. For example, the phase shifters 214 may perform amplification to include or replace the first or second amplifiers 212, 216. By way of another example, a phase shift may be implemented by the second mixer 208 to obviate the need for a separate phase shifter 214. This technique is sometimes called local oscillator (LO) phase shifting. In some aspects of this configuration, there may be multiple IF to RF mixers (for example, for each antenna element chain) within the second mixer 208, and the local oscillator B 232 may supply different local oscillator signals (with different phase offsets) to each IF to RF mixer.

The modem 202 or the controller/processor 234 may control one or more of the other components 204 through 272 to select one or more antenna elements 220 or to form beams for transmission of one or more signals. For example, the antenna elements 220 may be individually selected or deselected for transmission of a signal (or signals) by controlling an amplitude of one or more corresponding amplifiers, such as the first amplifiers 212 or the second amplifiers 216. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 220, the radiated signals interact, interfere (constructive and destructive interference), and amplify each other to form a resulting beam. The shape (such as the amplitude, width, or presence of side lobes) and the direction (such as an angle of the beam relative to a surface of the antenna array 218) can be dynamically controlled by modifying the phase shifts or phase offsets imparted by the phase shifters 214 and amplitudes imparted by the amplifiers 212, 216 of the multiple signals relative to each other. The controller/processor 234 may be located partially or fully within one or more other components of the architecture 200. For example, the controller/processor 234 may be located within the modem 202 in some aspects.

In some examples, ABF techniques may utilize phase shifters, amplitude control, or other techniques to co-phase antenna elements to improve radio performance, mitigate path loss, combat fading, increase throughput and reliability, or otherwise improve performance at a desired RF. ABF techniques are generally utilized in FR2 frequencies (for example, 24.25 GHz through 52.6 GHz), where antennas may be grouped across polarizations in an antenna module design. In contrast, ABF at FR1 (for example, from 410 MHz through 7.125 GHZ) frequencies or FR3 (for example, from 7.125 GHz through 24.25 GHz) frequencies pose challenges due to the antenna configurations that are typically used at such frequencies. For example, communication in FR1, FR3, or other sub-mmWave frequences often use PIFA elements, where a PIFA is a compact antenna structure in which a portion of the antenna is folded over itself and grounded to optimize space and enhance performance. Although PIFAs can be designed to support dual polarizations, practical PIFA designs are often monopoles, because dual polarized PIFA designs occupy more area (for example, up to approximately twice the area) and often do not support wideband applications. Furthermore, constructing antenna groups that can be co-phased to support ABF can be cumbersome, due to significant search and associated RS overhead.

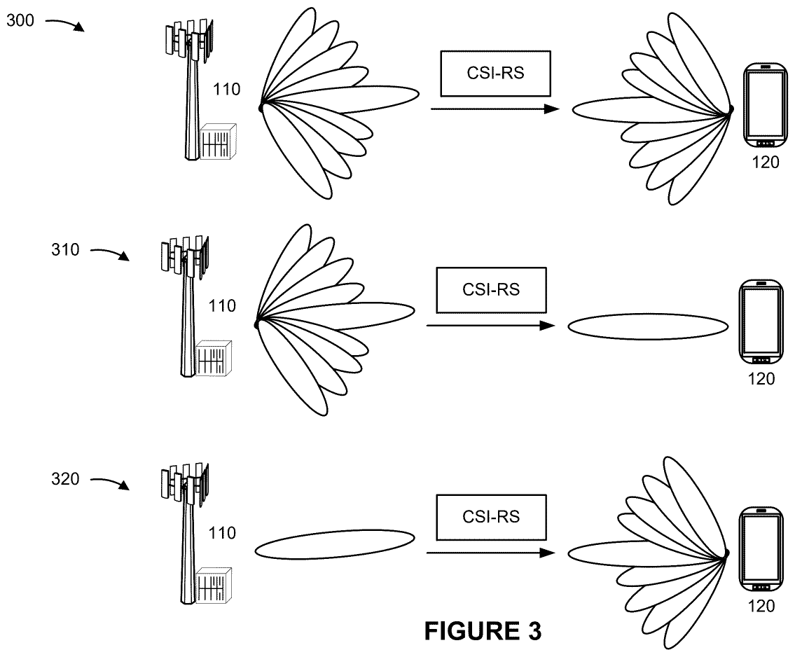

FIG. 3 is a diagram illustrating examples 300, 310, and 320 of CSI-RS beam management procedures. As shown in FIG. 3, examples 300, 310, and 320 include a UE 120 in communication with a network node 110 in a wireless network (for example, wireless communication network 100). However, the devices shown in FIG. 3 are provided as examples, and the wireless network may support communication and beam management between other devices (for example, between a UE 120 and a network node 110 or TRP, between a mobile termination node and a control node, between an IAB child node and an IA B parent node, or between a scheduled node and a scheduling node). In some aspects, the UE 120 and the network node 110 may be in a connected state (for example, an RRC connected state).

As shown in FIG. 3, example 300 may include a network node 110 (for example, one or more network node devices such as an RU, a DU, or a CU, among other examples) and a UE 120 communicating to perform beam management using CSI-RSs. Example 300 depicts a first beam management procedure (for example, P1 CSI-RS beam management). The first beam management procedure may be referred to as a beam selection procedure, an initial beam acquisition procedure, a beam sweeping procedure, a cell search procedure, or a beam search procedure. As shown in FIG. 3 and example 300, CSI-RSs may be configured to be transmitted from the network node 110 to the UE 120. The CSI-RSs may be configured to be periodic (for example, using RRC signaling), semi-persistent (for example, using MAC-CE signaling), or aperiodic (for example, using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (for example, with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (for example, P2 CSI-RS beam management). The second beam management procedure may be referred to as a beam refinement procedure, a network node beam refinement procedure, a TRP beam refinement procedure, or a transmit beam refinement procedure. As shown in FIG. 3 and example 310, CSI-RSs may be configured to be transmitted from the network node 110 to the UE 120. The CSI-RSs may be configured to be aperiodic (for example, using DCI). The second beam management procedure may include the network node 110 performing beam sweeping over one or more transmit beams. The one or more transmit beams may be a subset of all transmit beams associated with the network node 110 (for example, determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (for example, a same) receive beam (for example, determined based at least in part on measurements performed in connection with the first beam management procedure). The second beam management procedure may enable the network node 110 to select a best transmit beam based at least in part on measurements of the CSI-RSs (for example, measured by the UE 120 using the single receive beam) reported by the UE 120.

As shown in FIG. 3, example 320 depicts a third beam management procedure (for example, P3 CSI-RS beam management). The third beam management procedure may be referred to as a beam refinement procedure, a UE beam refinement procedure, or a receive beam refinement procedure. As shown in FIG. 3 and example 320, one or more CSI-RSs may be configured to be transmitted from the network node 110 to the UE 120. The CSI-RSs may be configured to be aperiodic (for example, using DCI). The third beam management process may include the network node 110 transmitting the one or more CSI-RSs using a single transmit beam (for example, determined based at least in part on measurements reported by the UE 120 in connection with the first beam management procedure or the second beam management procedure). To enable the UE 120 to perform receive beam sweeping, the network node may use a transmit beam to transmit (for example, with repetitions) CSI-RS at multiple times within the same RS resource set so that UE 120 can sweep through one or more receive beams in multiple transmission instances. The one or more receive beams may be a subset of all receive beams associated with the UE 120 (for example, determined based at least in part on measurements performed in connection with the first beam management procedure or the second beam management procedure). The third beam management procedure may enable the network node 110 or the UE 120 to select a best receive beam based at least in part on reported measurements received from the UE 120 (for example, of the CSI-RS of the transmit beam using the one or more receive beams).

Other examples of beam management procedures may differ from what is described with respect to FIG. 3 and examples 300, 310, or 320. For example, the UE 120 and the network node 110 may perform the third beam management procedure before performing the second beam management procedure, or the UE 120 and the network node 110 may perform a similar beam management procedure to select a UE transmit beam.

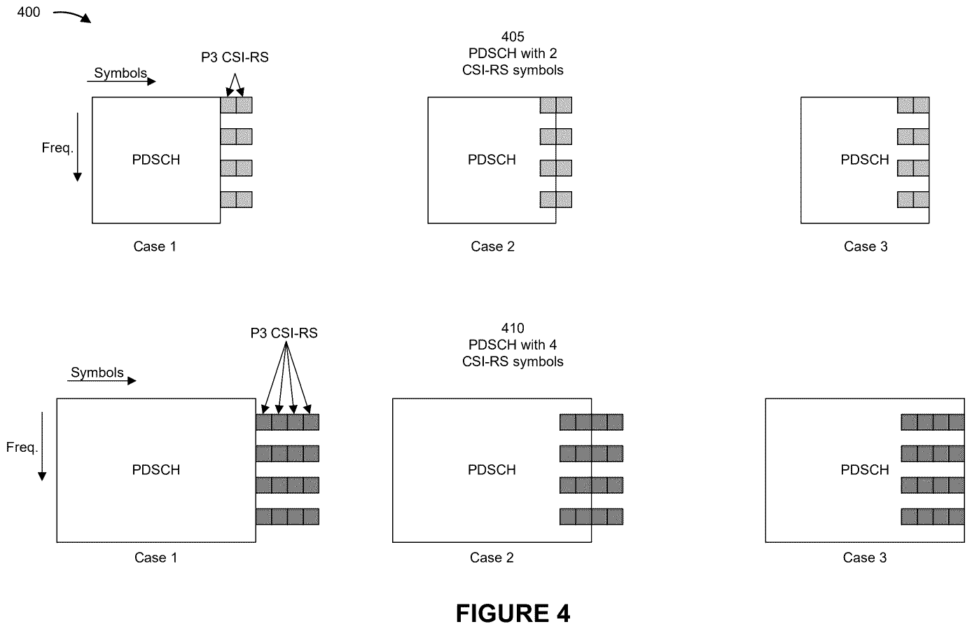

FIG. 4 is a diagram illustrating an example 400 of multiplexing of PDSCH and CSI-RS for ABF.

As described herein, ABF includes techniques that use phase shifters, amplitude control, or other techniques to co-phase antenna elements to improve radio performance, mitigate path loss, combat fading, increase throughput and reliability, or otherwise improve performance at a desired RF. ABF is typically used to improve a link budget at mmWave frequencies (for example, in FR2, which includes frequencies from 24.25 GHz through 52.6 GHz), where communication at high operating frequencies and shorter wavelengths may be impaired by increased blockage, penetration, and path losses. Accordingly, in FR2 or other mmWave frequencies, ABF techniques are often used to transmit and receive directional signals using antennas that are grouped across polarizations in an antenna module design. Although ABF may similarly improve performance at other frequencies, such as frequencies in FR1 (for example, from 410 MHz) or FR3 (for example, from 7.125 GHz through 24.25 GHz), extending ABF techniques to such frequencies poses challenges due to the antenna configurations that are typically used at such frequencies. For example, communication in FR1, FR3, or other sub-mmWave frequencies often use PIFA elements, where a PIFA is a compact antenna structure in which a portion of the antenna is folded over itself and grounded to optimize space and enhance performance. Although PIFAs can be designed to support dual polarizations, practical PIFA designs are often monopoles because dual polarized PIFA designs occupy more area and often do not support wideband applications. For example, such PIFA antenna designs may be placed arbitrarily within a UE without consistent ground plane orientation or optimal inter-element spacing. As a result, PIFA antenna designs may provide a decreased level of co-phasing capability relative to antennas designed for higher frequencies.

Additionally, an antenna selection process may include selecting the best antenna element and mapping it to an active radio chain, followed by sequentially mapping the next best antennas to the remaining active radio chains. This approach, known as antenna selection, may utilize a limited number of radio chains to maximize performance. However, the antenna selection process may discard a significant portion of the available antenna elements (for example, in scenarios in which a quantity of antennas exceeds the number of active radio chains), which may result in underutilization of the full antenna array and may lead to potential inefficiencies in signal reception and transmission.

Furthermore, constructing antenna groups that can be co-phased to support ABF can be cumbersome, due to significant search and associated RS overhead. For example, analog beamforming can be supported with different antenna elements with associated channels that have high cross-correlation coefficients that vary slowly over time. With antenna elements that have high cross-correlation coefficients, ABF coefficients or weights determined at measurement time can then provide a significant array gain during a reasonable time interval following the measurement time. Antenna elements within an antenna module (or panel) typically have high cross-correlation coefficients that support ABF due to antenna elements having spatial proximity and the same or similar directivity patterns and polarizations. However, antenna elements designed for FR1, FR3, or other sub-mmWave frequencies typically do not have high cross-correlation coefficients, are often placed such that associated channels are uncorrelated to achieve a high diversity gain through antenna selection, and are typically not oriented to point in any particular direction (for example, the antenna elements are typically used for omnidirectional communication).

In some examples, the UE may perform ABF utilizing Nᵣ antennas, and the UE may utilize beamforming weights gᵢ(i=1, . . . , Nᵣ) to sample a channel matrix H. For example, the system model for the symbols may be expressed as:

$${y}_{i} = {G}_{i}^{H} \cdot {Hf}_{network node} + {G}_{i}^{H} {n}_{i} , i = 1 , … , {N}_{r} ,$$

where γᵢ is a received symbol, H is a channel matrix, f_{network node} is a beamforming vector at a network node, and nᵢ is noise. Accordingly, in matrix form, the system model may be expressed as:

$$[ \begin{matrix}{y}_{1} \\ ⋮ \\ {y}_{{N}_{r}}\end{matrix} ] = [ \begin{matrix}{g}_{1}^{H} \\ ⋮ \\ {g}_{{N}_{r}}^{H}\end{matrix} ] \cdot {Hf}_{network node} + [ \begin{matrix}{g}_{1}^{H} {n}_{1} \\ ⋮ \\ {g}_{{N}_{r}}^{H} {n}_{{N}_{r}}\end{matrix} ] ,$$

and putting the received symbols together may enable estimation of the beamforming vector to be used at the UE (for example, the matched filter combiner to Hf_{network node}):

$${\hat{g}}_{UE} = {( [ \begin{matrix}{g}_{1}^{H} \\ ⋮ \\ {g}_{{N}_{r}}^{H}\end{matrix} ] )}^{- 1} \cdot [ \begin{matrix}{y}_{1} \\ ⋮ \\ {y}_{{N}_{r}}\end{matrix} ] ,$$

where gᵢ=[0 . . . 010 . . . 0]^{T} and the value of “1” corresponds to the ith antenna being selected, thereby enabling sampling of the ith row of H. In some other examples, an alternative unitary set of gᵢs may be used for estimating Hf_{network node}, but Nᵣ beamforming vectors are utilized in order to estimate respective ABF beam weights. As a result, ABF estimation or learning (for example, with P3 CSI-RS) may be performed in accordance with one or more configurations for multiplexing PDSCH and CSI-RS that account for the Nᵣ received signals for beamforming vectors.

For example, and as shown in FIG. 4, a network node and a UE may communicate using different multiplexing cases for PDSCH and CSI-RS for ABF with discrete antenna elements. For example, PDSCH and CSI-RS symbols may be multiplexed using TDM or FDM in accordance with one of a plurality of multiplexing cases.

As shown by reference number 405, a PDSCH communication may be multiplexed with two CSI-RS symbols. As shown in case 1 of reference number 405, a PDSCH communication may be multiplexed with two CSI-RS symbols using TDM, where the PDSCH symbols and CSI-RS symbols are scheduled in different time slots without overlap. As shown in case 2 of reference number 405, a PDSCH communication may be multiplexed using FDM with one CSI-RS resource (for example, where one CSI-RS symbol overlaps with PDSCH), and one CSI-RS symbol may be multiplexed with PDSCH using TDM (for example, where one CSI-RS symbol is scheduled without overlap with PDSCH). As shown in case 3 of reference number 405, all CSI-RS symbols may be multiplexed with PDSCH using FDM (for example, the two CSI-RS symbols overlap with PDSCH).

Furthermore, and as shown by reference number 410, a PDSCH communication may be multiplexed with four CSI-RS symbols. As shown in case 1 of reference number 410, a PDSCH communication may be multiplexed with four CSI-RS symbols using TDM, where the PDSCH symbols and CSI-RS symbols are scheduled in different time slots without overlap. As shown in case 2 of reference number 410, a PDSCH communication may be multiplexed using FDM with two CSI-RS symbols (for example, where two CSI-RS symbols overlap with PDSCH), and two CSI-RS symbols may be multiplexed with PDSCH using TDM (for example, where CSI-RS symbols are scheduled without overlap with PDSCH). As shown in case 3 of reference number 410, all CSI-RS symbols may be multiplexed with PDSCH using FDM (for example, the four CSI-RS symbols overlap with PDSCH).

In case 1 of reference number 405 and reference number 410, because PDSCH and CSI-RS are scheduled in different symbols, the UE may use different ABF beam weights (for example, gᵢ) for each of the CSI-RS symbols in order to learn ABF beam weights (for example, ĝ_{UE}) to be used in ABF, thereby enabling estimation of the channel matrix and optimizing beamforming for subsequent PDSCH communications. As a result, where there is no overlap between PDSCH and CSI-RS (for example, PDSCH and CSI-RS are multiplexed using only TDM), ABF techniques may be performed.

As shown in case 2 of reference number 405 and reference number 410, where a first set of CSI-RS symbols and a PDSCH communication are multiplexed using FDM (for example, where CSI-RS symbols overlap with PDSCH), and a second set of CSI-RS symbols and a PDSCH communication are multiplexed using TDM (for example, where CSI-RS symbols are scheduled without overlap with PDSCH), estimating ABF beam weights may be affected in accordance with the quantity of antennas (for example, the value of Nᵣ).

For example, and as shown by reference number 405, where Nᵣ=2 antennas for ABF, the UE may use a PDSCH beam weight (for example, denoted as w) for the first (for example, overlapping) CSI-RS symbol as a sampling beam (for example, a beam weight configuration used to sample the CSI-RS for ABF), and the UE may use an orthogonal or unitary beam weight (for example, denoted as u) for the second (for example, non-overlapping) CSI-RS symbol. With these two beam weights (for example, w and u), the UE may determine one or more ABF beam weights for use with a subsequent PDSCH.

Furthermore, for example, and as shown by reference number 410, where Nᵣ=4 antennas for ABF, the UE may be limited to using a single ABF beam weight for two CSI-RS symbols, thereby preventing ABF beam weight learning. As a result, in a partial overlap scenario (for example, where one or more CSI-RS symbols are scheduled to overlap with PDSCH, and one or more CSI-RS symbols are scheduled without overlap with PDSCH), only one CSI-RS symbol may be multiplexed with PDSCH using FDM (for example, only one CSI-RS symbol may be scheduled to overlap with PDSCH), whereas Nᵣ−1 CSI-RS symbols may be multiplexed with PDSCH using TDM (for example, Nᵣ−1 symbols may be scheduled without overlap with PDSCH) in order to perform ABF beam weight learning or estimation. Additionally, such a scheduling limitation may enable consistent determination of ĝ_{UE} (for example, obtaining Nᵣ unique measurements for estimating ABF beam weights over Nᵣ antennas may be utilized in order to perform ABF beam weight learning or estimation). Accordingly, where only K (for example, where K<Nᵣ) unique measurements are available in case 2 (for example, a partial overlap between PDSCH and CSI-RS), the ABF system may be underdetermined, but the UE may utilize a least squares estimate (or other objective-function-based estimate) of ĝ_{UE}. As a result, the obtained ABF beam weights may be of relatively lower accuracy (for example, for increasing performance optimization), but the ABF beam weights may be suitable for relatively increased improvements in performance.

As shown in case 3 of reference number 405 and reference number 410, where all CSI-RS symbols and a PDSCH communication are multiplexed using FDM (for example, where all CSI-RS symbols overlap with PDSCH), estimating ABF beam weights may be unsupported. Accordingly, some aspects described herein relate to techniques to enable ABF with discrete antennas via scheduling configurations related to multiplexing of PDSCH and CSI-RS symbols (for example, P3 CSI-RS symbols) in the context of ABF.

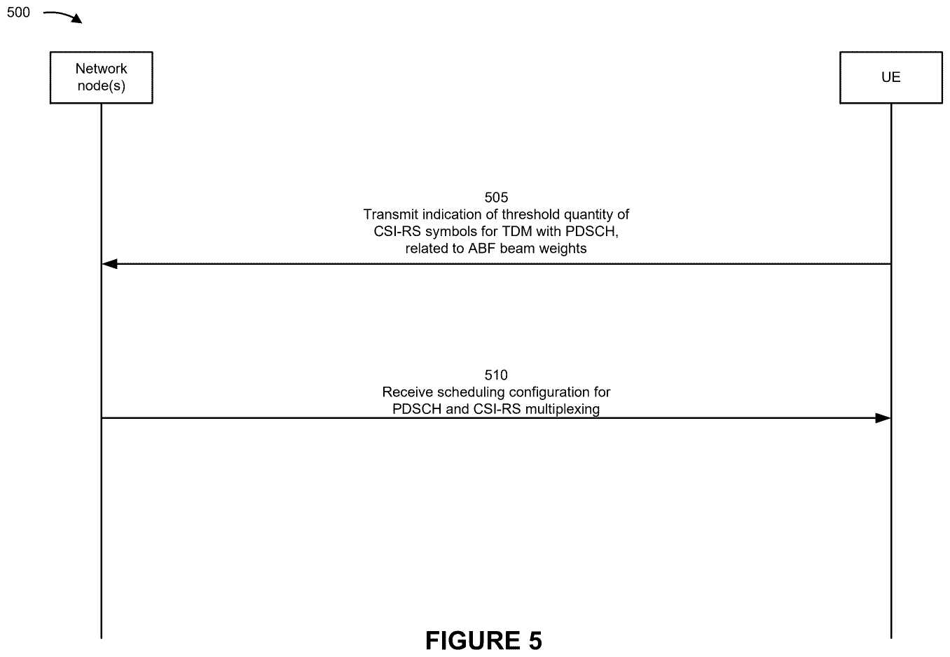

FIG. 5 is a diagram illustrating an example 500 associated with scheduling configurations for ABF with discrete antenna elements. As shown in FIG. 5, a network node (for example, network node 110) and a UE (for example, UE 120) may communicate with one another.

In a first operation 505, the UE may transmit, and the network node may receive, an indication of a threshold quantity of CSI-RS symbols for TDM with a PDSCH communication, related to one or more ABF beam weights for one or more discrete antenna elements. For example, the UE may determine the threshold quantity of CSI-RS symbols (for example, P3 CSI-RS symbols) in accordance with a quantity of antenna elements and an ABF configuration. This determination may enable the UE to perform effective ABF by utilizing the specified threshold quantity of CSI-RS symbols in conjunction with PDSCH communications. In some aspects, a quantity of estimated beam weights may be greater than a quantity of antennas combined with ABF. Additionally, in some aspects, the indication may be provided periodically, continuously, or multiple times over a time period in order to enable a consistent estimate of the ABF beam weights. In some aspects, the ABF beam weights are related to FR1 (for example, an FR1 configuration) or to FR2 (for example, an FR2 configuration).

In some aspects, the threshold quantity of CSI-RS symbols may be determined in accordance with historical data related to ABF performance. For example, the network node may analyze past ABF performance data to predict or estimate an optimal quantity of CSI-RS symbols for current network conditions. Additionally or alternatively, the UE or the network node may use AI/ML techniques to dynamically determine and adjust the threshold quantity of CSI-RS symbols to improve ABF performance. This approach enables the UE or the network node to adapt the scheduling configuration in accordance with changing network conditions or UE performance.

In a second operation 510, the network node may transmit, and the UE may receive, a scheduling configuration for PDSCH and CSI-RS symbol multiplexing. In some aspects, the scheduling configuration may be transmitted in accordance with the indication, received from the UE, indicating activation of an ABF estimation configuration related to the UE. In some aspects, the scheduling configuration may be related to one or more beams used in a beam refinement sweeping procedure. In some aspects, the network node may restrict the quantity of CSI-RS symbols that are multiplexed with PDSCH using FDM and the quantity of CSI-RS symbols that are multiplexed with PDSCH using TDM.

Additionally or alternatively, in some aspects, a first ABF beam weight may be used with a first set of CSI-RS symbols, in accordance with the scheduling configuration, and a second ABF beam weight may be used with a second set of CSI-RS symbols, in accordance with the scheduling configuration. For example, the UE may use a first beam weight for the first set of CSI-RS symbols as a sampling beam, and the UE may use a second beam weight for the second set of CSI-RS symbols at an orthogonal or unitary beam weight.

In some aspects, where a quantity of estimated ABF beam weights is greater than a quantity of antenna elements, the accuracy and efficiency of ABF estimation may be improved. Additionally or alternatively, where the quantity of CSI-RS symbols (for example, P3 CSI-RS symbols) that are multiplexed with PDSCH using TDM is less than the threshold quantity, the UE may indicate ABF beam weight estimations that are related to the scheduling configuration. In some aspects, the indicated measure of ABF gains may be relatively smaller (for example, relative to circumstances in which the quantity of CSI-RS symbols multiplexed with PDSCH using TDM is greater than the threshold quantity) because the ABF system may be underdetermined.

In some aspects, the UE may provide feedback to the network node in accordance with the received indication, which includes the number of CSI-RS symbols for effective ABF beam weight estimation. For example, the UE may indicate a threshold (for example, minimum) quantity of CSI-RS symbols for effective ABF beam weight learning. For example, this threshold quantity may be greater than the quantity of antennas combined with ABF to ensure consistent ABF performance. If the quantity of CSI-RS symbols multiplexed with PDSCH using TDM is less than the threshold quantity, the UE can indicate a measure of the possible ABF gains. The network node can then restrict the multiplexing of CSI-RS symbols and inform the UE, ensuring that the CSI-RS symbols are effectively used for ABF beam weight learning. This signaling and restriction mechanism ensures optimal ABF performance and power-performance tradeoffs in different frequency ranges, particularly in FR1 and FR3. The network node may then adjust the scheduling configuration to ensure that the CSI-RS symbols are time-division multiplexed with PDSCH communications in accordance with the indication, enabling the UE to perform ABF using the specified beam weights. This configuration ensures optimal performance and efficient use of network resources while supporting the ABF feature in FR1 or FR3 frequencies. In some aspects, the UE may not expect to receive both PDSCH and CSI-RS (for example, P3 CSI-RS) with repetition on, where the PDSCH and CSI-RS are overlapped in greater than a fixed quantity, K, of symbols, and K is configured by the network node.

In some aspects, the scheduling configuration may be adjusted in accordance with real-time network conditions, such as channel quality and traffic load, to ensure optimal ABF performance and to reduce power consumption. For example, the network node can monitor current channel conditions and dynamically alter the scheduling configuration to increase efficiency. Additionally or alternatively, the network node may receive feedback from one or more UEs to adapt the scheduling configuration in accordance with the threshold quantity of CSI-RS symbols for multiplexing, indicated by the one or more UEs. This aggregated feedback enables the network node to make more informed decisions that benefit overall network performance.

As described herein, a network node may provide a scheduling configuration for ABF techniques that use discrete antennas, including in relatively lower frequency ranges (for example, FR1 or FR3). Additionally, a UE may transmit, to a network node, an indication of a threshold quantity of CSI-RS symbols for TDM with a PDSCH communication. The indication may be related to one or more ABF beam weights for one or more discrete antenna elements. The UE may then receive, from the network node, a scheduling configuration for PDSCH and CSI-RS symbol multiplexing in accordance with the indication. In some aspects, the UE may estimate the ABF beam weights in accordance with the scheduling configuration, wherein a first ABF beam weight is used with a first set of CSI-RS symbols, and a second ABF beam weight is used with a second set of CSI-RS symbols, in accordance with the scheduling configuration. Additionally, the scheduling configuration may relate to one or more beams used in a beam refinement sweeping procedure. In some aspects, the UE may transmit an indication of ABF beam weight estimations when the quantity of CSI-RS symbols is less than the threshold quantity.

By transmitting an indication of the threshold quantity of CSI-RS symbols for TDM with PDSCH, the UE enables the network node to adapt the scheduling configuration to the UE's ABF implementation. This may result in increased efficiency in energy usage for targeted beam directions and may lead to an enhancement of the link budget across different antenna configurations. Additionally, by receiving a scheduling configuration that considers the UE's ABF capabilities or ABF implementation, the UE can more accurately estimate ABF beam weights, thereby improving ABF performance under different system conditions and across a relatively wider range of frequencies. Furthermore, the network node may adapt the scheduling configuration to optimize the use of radio resources by efficiently multiplexing CSI-RS symbols via FDM or TDM, thus preserving throughput while minimizing signaling overhead. Such an adaptation to the scheduling configuration may improve spectral efficiency or reduce network congestion. Additionally, the exchange of ABF-related information between the UE and the network node may improve synchronization between the UE and the network node, which may improve signal quality, reduce interference, and improve spectral efficiency.

FIG. 6 is a flowchart illustrating an example process 600 performed, for example, at a UE or an apparatus of a UE that supports scheduling configurations for ABF with discrete antenna elements. Example process 600 is an example where the apparatus or the UE (for example, UE 120) performs operations associated with scheduling configurations for ABF with discrete antenna elements.

As shown in FIG. 6, in some aspects, process 600 may include transmitting, to a network node, an indication of a threshold quantity of CSI-RS symbols for TDM with a PDSCH communication, related to one or more ABF beam weights for one or more discrete antenna elements (block 610). For example, the UE (such as by using communication manager 150 or transmission component 804, depicted in FIG. 8) may transmit, to a network node, an indication of a threshold quantity of CSI-RS symbols for TDM with a PDSCH communication, related to one or more ABF beam weights for one or more discrete antenna elements, as described above.

As further shown in FIG. 6, in some aspects, process 600 may include receiving, from the network node, a scheduling configuration, for PDSCH and CSI-RS symbol multiplexing, in accordance with the indication (block 620). For example, the UE (such as by using communication manager 150 or reception component 802, depicted in FIG. 8) may receive, from the network node, a scheduling configuration, for PDSCH and CSI-RS symbol multiplexing, in accordance with the indication, as described above.

Process 600 may include additional aspects, such as any single aspect or any combination of aspects described below or in connection with one or more other processes described elsewhere herein

In a first additional aspect, process 600 includes estimating the one or more ABF beam weights according to the scheduling configuration.

In a second additional aspect, alone or in combination with the first aspect, a first ABF beam weight is used with a first set of CSI-RS symbols, in accordance with the scheduling configuration, and a second ABF beam weight is used with a second set of CSI-RS symbols, in accordance with the scheduling configuration.

In a third additional aspect, alone or in combination with one or more of the first and second aspects, a quantity of estimated ABF beam weights is greater than a quantity of antenna elements.

In a fourth additional aspect, alone or in combination with one or more of the first through third aspects, the one or more ABF beam weights are related to an FR1 configuration or an FR3 configuration.

In a fifth additional aspect, alone or in combination with one or more of the first through fourth aspects, the scheduling configuration is related to one or more beams used in a beam refinement sweeping procedure.

In a sixth additional aspect, alone or in combination with one or more of the first through fifth aspects, process 600 includes transmitting, to the network node, an indication of ABF beam weight estimations, according to the scheduling configuration indicating a quantity of CSI-RS symbols that is less than the threshold quantity of CSI-RS symbols.

In a seventh additional aspect, alone or in combination with one or more of the first through sixth aspects, the indication indicates activation of an ABF estimation configuration related to the UE.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports scheduling configurations for ABF with discrete antenna elements. Example process 700 is an example where the apparatus or the network node (for example, network node 110) performs operations associated with scheduling configurations for ABF with discrete antenna elements.

As shown in FIG. 7, in some aspects, process 700 may include receiving, from a UE, an indication of a threshold quantity of CSI-RS symbols for TDM with a PDSCH communication, related to one or more ABF beam weights for one or more discrete antenna elements (block 710). For example, the network node (such as by using communication manager 150 or reception component 902, depicted in FIG. 9) may receive, from a UE, an indication of a threshold quantity of CSI-RS symbols for TDM with a PDSCH communication, related to one or more ABF beam weights for one or more discrete antenna elements, as described above.

As further shown in FIG. 7, in some aspects, process 700 may include transmitting, to the UE, a scheduling configuration, for PDSCH and CSI-RS symbol multiplexing, in accordance with the indication (block 720). For example, the network node (such as by using communication manager 150 or transmission component 904, depicted in FIG. 9) may transmit, to the UE, a scheduling configuration, for PDSCH and CSI-RS symbol multiplexing, in accordance with the indication, as described above.

Process 700 may include additional aspects, such as any single aspect or any combination of aspects described below or in connection with one or more other processes described elsewhere herein.

In a first additional aspect, a quantity of estimated ABF beam weights is greater than a quantity of antenna elements.

In a second additional aspect, alone or in combination with the first aspect, the one or more ABF beam weights are related to an FR1 configuration or an FR3 configuration.

In a third additional aspect, alone or in combination with one or more of the first and second aspects, the scheduling configuration is related to one or more beams used in a beam refinement sweeping procedure.

In a fourth additional aspect, alone or in combination with one or more of the first through third aspects, process 700 includes receiving, from the UE, an indication of ABF beam weight estimations, according to the scheduling configuration indicating a quantity of CSI-RS symbols that is less than the threshold quantity of CSI-RS symbols.

In a fifth additional aspect, alone or in combination with one or more of the first through fourth aspects, the indication indicates activation of an ABF estimation configuration related to the UE.

In a sixth additional aspect, alone or in combination with one or more of the first through fifth aspects, the scheduling configuration is transmitted based on the indication indicating activation of the ABF estimation configuration related to the UE.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports scheduling configurations for ABF with discrete antenna elements. The apparatus 800 may be a UE, or a UE may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 140). In some aspects, the communication manager 806 is the communication manager 150.

In some aspects, the apparatus 800 may be configured to or operable to perform one or more operations described herein in connection with FIG. 5. Additionally or alternatively, the apparatus 800 may be configured to or operable to perform one or more processes described herein, such as process 600 of FIG. 6.

The reception component 802 may receive communications, such as reference signals, control information, or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the UE described above in connection with FIG. 1, such as a radio, one or more RF chains, one or more transceivers, or one or more modems, each of which may in turn be coupled with one or more antennas of the UE. In some aspects, the transmission component 804 may be co-located with the reception component 802.

The communication manager 806 may transmit or may cause the transmission component 804 to transmit, to a network node, an indication of a threshold quantity of CSI-RS symbols for TDM with a PDSCH communication, related to one or more ABF beam weights for one or more discrete antenna elements. The communication manager 806 may receive or may cause the reception component 802 to receive, from the network node, a scheduling configuration, for PDSCH and CSI-RS symbol multiplexing, in accordance with the indication. In some aspects, the communication manager 806 may perform one or more operations described elsewhere herein as being performed by one or more components of the communication manager 806.

In some aspects, the communication manager 806 includes a set of components, such as an estimation component 810. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 804 may transmit, to a network node, an indication of a threshold quantity of CSI-RS symbols for TDM with a PDSCH communication, related to one or more ABF beam weights for one or more discrete antenna elements. The reception component 802 may receive, from the network node, a scheduling configuration, for PDSCH and CSI-RS symbol multiplexing, in accordance with the indication.

The estimation component 810 may estimate the one or more ABF beam weights according to the scheduling configuration.

The transmission component 804 may transmit, to the network node, an indication of ABF beam weight estimations, according to the scheduling configuration indicating a quantity of CSI-RS symbols that is less than the threshold quantity of CSI-RS symbols.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports scheduling configurations for ABF with discrete antenna elements. The apparatus 900 may be a network node, or a network node may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145). In some aspects, the communication manager 906 is the communication manager 155

In some aspects, the apparatus 900 may be configured to or operable to perform one or more operations described herein in connection with FIGS. 5. Additionally or alternatively, the apparatus 900 may be configured to or operable to perform one or more processes described herein, such as process 700 of FIG. 7.

The reception component 902 may receive communications, such as reference signals, control information, or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the network node described above in connection with FIG. 1, such as a radio, one or more RF chains, one or more transceivers, or one or more modems, each of which may in turn be coupled with one or more antennas of the network node.

The transmission component 904 may transmit communications, such as reference signals, control information, or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the network node described above in connection with FIG. 1, such as a radio, one or more RF chains, one or more transceivers, or one or more modems, each of which may in turn be coupled with one or more antennas of the network node. In some aspects, the transmission component 904 may be co-located with the reception component 902.

The communication manager 906 may receive or may cause the reception component 902 to receive, from a UE, an indication of a threshold quantity of CSI-RS symbols for TDM with a PDSCH communication, related to one or more ABF beam weights for one or more discrete antenna elements. The communication manager 906 may transmit or may cause the transmission component 904 to transmit, to the UE, a scheduling configuration, for PDSCH and CSI-RS symbol multiplexing, in accordance with the indication. In some aspects, the communication manager 906 may perform one or more operations described elsewhere herein as being performed by one or more components of the communication manager 906.

In some aspects, the communication manager 906 includes a set of components. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 902 may receive, from a UE, an indication of a threshold quantity of CSI-RS symbols for TDM with a PDSCH communication, related to one or more ABF beam weights for one or more discrete antenna elements. The transmission component 904 may transmit, to the UE, a scheduling configuration, for PDSCH and CSI-RS symbol multiplexing, in accordance with the indication.

The reception component 902 may receive, from the UE, an indication of ABF beam weight estimations, according to the scheduling configuration indicating a quantity of CSI-RS symbols that is less than the threshold quantity of CSI-RS symbols.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method for wireless communication by a user equipment (UE), comprising: transmitting, to a network node, an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements; and receiving, from the network node, a scheduling configuration, for PDSCH and CSI-RS symbol multiplexing, in accordance with the indication.

Aspect 2: The method of Aspect 1, further comprising: estimating the one or more ABF beam weights according to the scheduling configuration.

Aspect 3: The method of Aspect 2, wherein a first ABF beam weight is used with a first set of CSI-RS symbols, in accordance with the scheduling configuration, and a second ABF beam weight is used with a second set of CSI-RS symbols, in accordance with the scheduling configuration.

Aspect 4: The method of any of Aspects 1-3, wherein a quantity of estimated ABF beam weights is greater than a quantity of antenna elements.

Aspect 5: The method of any of Aspects 1-4, wherein the one or more ABF beam weights are related to a frequency range 1 (FR1) configuration or a frequency range 3 (FR3) configuration.

Aspect 6: The method of any of Aspects 1-5, wherein the scheduling configuration is related to one or more beams used in a beam refinement sweeping procedure.

Aspect 7: The method of any of Aspects 1-6, further comprising: transmitting, to the network node, an indication of ABF beam weight estimations, according to the scheduling configuration indicating a quantity of CSI-RS symbols that is less than the threshold quantity of CSI-RS symbols.

Aspect 8: The method of any of Aspects 1-7, wherein the indication indicates activation of an ABF estimation configuration related to the UE.

Aspect 9: A method for wireless communication by a network node, comprising: receiving, from a user equipment (UE), an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements; and transmitting, to the UE, a scheduling configuration, for PDSCH and CSI-RS symbol multiplexing, in accordance with the indication.

Aspect 10: The method of Aspect 9, wherein a quantity of estimated ABF beam weights is greater than a quantity of antenna elements.

Aspect 11: The method of any of Aspects 9-10, wherein the one or more ABF beam weights are related to a frequency range 1 (FR1) configuration or a frequency range 3 (FR3) configuration.

Aspect 12: The method of any of Aspects 9-11, wherein the scheduling configuration is related to one or more beams used in a beam refinement sweeping procedure.

Aspect 13: The method of any of Aspects 9-12, further comprising: receiving, from the UE, an indication of ABF beam weight estimations, according to the scheduling configuration indicating a quantity of CSI-RS symbols that is less than the threshold quantity of CSI-RS symbols.

Aspect 14: The method of any of Aspects 9-13, wherein the indication indicates activation of an ABF estimation configuration related to the UE.

Aspect 15: The method of Aspect 14, wherein the scheduling configuration is transmitted based on the indication indicating activation of the ABF estimation configuration related to the UE.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

Aspect 23: A device comprising a processing system that includes one or more processors and one or more code-storing memories coupled with the one or more processors, the processing system configured to cause the device to perform the method of one or more of Aspects 1-15.

Aspect 24: A device comprising a processing system that includes processor circuitry and code-storing memory circuitry, the processing system configured to cause the device to perform the method of one or more of Aspects 1-15.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. M any of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a network node, an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements; and
receive, from the network node, a scheduling configuration, for PDSCH and CSI-RS symbol multiplexing, in accordance with the indication.

2. The UE of claim 1, wherein the processing system is configured to cause the UE to:
estimate the one or more ABF beam weights according to the scheduling configuration.

3. The UE of claim 2, wherein a first ABF beam weight is used with a first set of CSI-RS symbols, in accordance with the scheduling configuration, and a second ABF beam weight is used with a second set of CSI-RS symbols, in accordance with the scheduling configuration.

4. The UE of claim 1, wherein a quantity of estimated ABF beam weights is greater than a quantity of antenna elements.

5. The UE of claim 1, wherein the one or more ABF beam weights are related to a frequency range 1 (FR1) configuration or a frequency range 3 (FR3) configuration.

6. The UE of claim 1, wherein the scheduling configuration is related to one or more beams used in a beam refinement sweeping procedure.

7. The UE of claim 1, wherein the processing system is configured to cause the UE to:
transmit, to the network node, an indication of ABF beam weight estimations, according to the scheduling configuration indicating a quantity of CSI-RS symbols that is less than the threshold quantity of CSI-RS symbols.

8. The UE of claim 1, wherein the indication indicates activation of an ABF estimation configuration related to the UE.

9. A network node, comprising:
a processing system that includes one or more processors and one or more code-storing memories coupled with the one or more processors, the processing system configured to cause the network node to:
receive, from a user equipment (UE), an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements; and
transmit, to the UE, a scheduling configuration, for PDSCH and CSI-RS symbol multiplexing, in accordance with the indication.

10. The network node of claim 9, wherein a quantity of estimated ABF beam weights is greater than a quantity of antenna elements.

11. The network node of claim 9, wherein the one or more ABF beam weights are related to a frequency range 1 (FR1) configuration or a frequency range 3 (FR3) configuration.

12. The network node of claim 9, wherein the scheduling configuration is related to one or more beams used in a beam refinement sweeping procedure.

13. The network node of claim 9, wherein the processing system is configured to cause the network node to:
receive, from the UE, an indication of ABF beam weight estimations, according to the scheduling configuration indicating a quantity of CSI-RS symbols that is less than the threshold quantity of CSI-RS symbols.

14. The network node of claim 9, wherein the indication indicates activation of an ABF estimation configuration related to the UE.

15. The network node of claim 14, wherein the scheduling configuration is transmitted based on the indication indicating activation of the ABF estimation configuration related to the UE.

16. A method for wireless communication by a user equipment (UE), comprising:
transmitting, to a network node, an indication of a threshold quantity of channel state information reference signal (CSI-RS) symbols for time-division multiplexing with a physical downlink shared channel (PDSCH) communication, related to one or more analog beamforming (ABF) beam weights for one or more discrete antenna elements; and
receiving, from the network node, a scheduling configuration, for PDSCH and CSI-RS symbol multiplexing, in accordance with the indication.

17. The method of claim 16, further comprising:
estimating the one or more ABF beam weights according to the scheduling configuration.

18. The method of claim 17, wherein a first ABF beam weight is used with a first set of CSI-RS symbols, in accordance with the scheduling configuration, and a second ABF beam weight is used with a second set of CSI-RS symbols, in accordance with the scheduling configuration.

19. The method of claim 16, wherein the one or more ABF beam weights are related to a frequency range 1 (FR1) configuration or a frequency range 3 (FR3) configuration.

20. The method of claim 16, further comprising:
transmitting, to the network node, an indication of ABF beam weight estimations, according to the scheduling configuration indicating a quantity of CSI-RS symbols that is less than the threshold quantity of CSI-RS symbols.
